(19) United States
(12) Patent Application Publication
(10) Pub. No.: US 2016/0300232 A1
(43) Pub. Date: Oct. 13, 2016

(54) MONITORING ASSISTANCE DEVICE

(71) Applicant: RAKUTEN, INC., Tokyo (JP)

(72) Inventor: Naoki TSUKADA, Tokyo (JP)

(73) Assignee: Rakuten, Inc., Tokyo (JP)

(21) Appl. No.: 15/036,087

(22) PCT Filed: Nov. 13, 2013
(86) PCT No.: PCT/JP2013/080699

§ 371 Date: May 12, 2016

(51) Int. Cl. G06Q 20/40; G06Q 30/06

(52) U.S. Cl. CPC G06Q 20/4016; G06Q 30/0633

(57) ABSTRACT

To provide a monitoring assistance device capable of extracting suspicious orders from order information received in electronic commerce from various viewpoints.

The monitoring assistance device obtains received order data including a plurality of records indicating the contents of orders received by electronic commerce. At a predetermined first frequency, the monitoring assistance device compares the contents of a comparison object record received within a corresponding period in the obtained received order data with an extraction object list prepared in advance, and outputs the comparison object record as a first extraction result when the comparison object record satisfies a predetermined first extraction condition as a result of the comparison. At a second frequency lower than the first frequency, the monitoring assistance device aggregates a plurality of aggregation object records received within a predetermined period in the past with a predetermined field as a key, and outputs information obtained by the aggregation as an aggregation result.

### TECHNICAL FIELD

The present invention relates to a monitoring assistance device used to assist in monitoring orders received in electronic commerce, and a method of controlling the monitoring assistance device.

### BACKGROUND ART

In a field of electronic commerce, a large number of orders occur every day. The orders include an order undesirable to an order receiver, such as an order fraudulently using a credit card. The order receiver therefore needs to monitor whether there are suspicious orders. However, it is often difficult to monitor all of the large number of orders manually. Accordingly, a method has been proposed which extracts transactions highly likely to be fraudulent acts by using predetermined patterns of fraudulent acts, for example (see Patent Document 1).

### PRIOR ART DOCUMENT

### [Patent Document]

[Patent Document 1]

Japanese Patent Laid-Open No. 2008-021144

### SUMMARY

### Technical Problem

In the above-described method, attention is directed to each individual transaction to determine whether or not the transaction is a suspicious transaction. However, there are cases where the method alone cannot be said to be sufficient to find suspicious orders. In order to find suspicious orders at an early stage, the monitoring of orders from various viewpoints is desired to be performed.

The present invention has been made in consideration of the above-described actual situation. It is an object of the present invention to provide a monitoring assistance device that can extract suspicious orders from order information received in electronic commerce from various viewpoints, and a method of controlling the monitoring assistance device.

### Solution to Problem

A monitoring assistance device according to the present invention is a monitoring assistance device for use in monitoring orders received by electronic commerce, the monitoring assistance device including: received order data obtaining means for obtaining received order data including a plurality of records each indicating contents of an order; extraction result outputting means for, at a predetermined first frequency, comparing contents of a comparison object record received within a corresponding period in the received order data with an extraction object list prepared in advance, and outputting the comparison object record as a first extraction result when the comparison object record satisfies a predetermined first extraction condition as a result of the comparison; and aggregation result outputting means for, at a second frequency lower than the first frequency, aggregating a plurality of aggregation object records received within a predetermined period in a past with a predetermined field as a key, and outputting information obtained by the aggregation as an aggregation result.

### BRIEF DESCRIPTION OF DRAWINGS

FIG. 1 is a schematic diagram of an electronic commerce system including a monitoring assistance device according to an embodiment of the present invention.

FIG. 2 is a configuration block diagram of the monitoring assistance device according to the embodiment of the present invention.

FIG. 3 is a functional block diagram of the monitoring assistance device according to the embodiment of the present invention.

FIG. 4 is a diagram showing an example of contents of received order data OD.

FIG. 5 is a diagram showing an example of contents of an extraction object list BL.

FIG. 6 is a diagram showing an example of contents of an exclusion object list WL.

FIG. 7 is a flowchart showing an example of a flow of first extraction processing.

FIG. 8 is a diagram showing an example of contents of summary data SD.

FIG. 9 is a diagram showing an example of contents of detail data DD.

FIG. 10 is a flowchart showing an example of a flow of second extraction processing.

### DESCRIPTION OF EMBODIMENT

An embodiment of the present invention will hereinafter be described in detail with reference to the drawings.

When a purchase is made by credit card, “authorization” is performed before settlement. In a case where the number of a credit card that is about to be used is a number registered as an unusable number by a credit card company, the authorization fails, and the settlement cannot be made. By registering in advance the card number whose fraudulent use has been reported as an unusable number, the card company can exclude fraudulent use of the card in a stage of authorization.

In actuality, however, a considerable period may be taken for the card company to register the card as a fraudulent card after a start of fraudulent use of the card. During that period, the fraudulent use of the card cannot be excluded by authorization. Hence, during that period, there is a possibility of occurrence of a chargeback or the like even though a result of authorization indicates success (see Japanese Patent Laid-Open No. 2005-332416, for example).

In a transaction at an actual store, when a clerk compares a photograph on a card with a customer, or compares a signature on a face of the card with a signature on a sales slip (or checks for a suspicious tint or texture of the card), an initial fraudulent use of the card which initial fraudulent use cannot be excluded by authorization can be detected. However, this is not the case when a credit card is used as means for settlement in electronic commerce. Hence, some contrivance to prevent fraudulent use of credit cards in electronic commerce from an initial stage is necessary.

In a mall type electronic commerce service, an electronic commerce server (intermediary server) provided by a service provider intermediating between purchasers and sellers is a first receiver of order information. Therefore, fraudulent use of credit cards may be reduced by monitoring order information accumulated in the intermediary server, and picking up suspicious orders. However, it is impractical to monitor, with the eyes of a human, all of order information that increases on the order of a few hundred or a few thousand per minute. Accordingly, Patent Document 1, for example, describes automatically extracting transactions highly likely to be fraudulent acts from a transaction log by using a mathematical model, and updating the mathematical model on the basis of information on incidents that actually occurred.

However, the technology of Patent Document 1 updates the mathematical model after the actual occurrence of the incidents on the basis of the information on the incidents, and is thus not entirely satisfactory from a viewpoint of preventing the incidents. Methods of fraudulent use are now becoming more sophisticated every day, and those who are to prevent the fraudulent use are therefore desired to deal with the fraudulent use with commensurate speediness. Accordingly, it is an object of a monitoring assistance device 1 according to the present embodiment to provide a technology that assists a monitoring person (operator) who monitors order information in detecting methods of new frauds at an early stage (before incidents actually occur).

FIG. 1 is a schematic diagram of an electronic commerce system including a monitoring assistance device 1 according to one embodiment of the present invention. In the present embodiment, suppose that electronic commerce is conducted by an electronic mall service in which a plurality of stores are opened in a virtually constructed electronic mall (cybermall) and each store sells products to general consumers.

Specifically, a provider of the electronic mall service provides an electronic commerce server 2. The electronic commerce server 2 is a server computer that implements functions of an electronic mall in which plural stores conducting electronic commerce gather. The electronic commerce server 2 provides functions of introducing products, receiving orders, assisting in settlement and physical distribution, and the like. A person who desires to open a store in the electronic mall contracts with the provider of the electronic mall service, and opens a store on the electronic commerce server 2. Then, the person accesses the electronic commerce server 2 using a store server 3, and registers products to be sold with the electronic commerce server 2. An orderer accesses the electronic commerce server 2 via a communication network such as the Internet or the like using an orderer terminal 4, and orders a product. The electronic commerce server 2 provides the store server 3 with received order data indicating the contents of the received order. The store ships the product for which the order has been received to the orderer on the basis of the received order data.

In particular, in the present embodiment, when the electronic commerce server 2 receives an order using a credit card as means for settlement, the electronic commerce server 2 first performs authorization for the credit card. Specifically, the electronic commerce server 2 makes an inquiry to a server of the card company via a network to confirm whether the credit card used for the order is usable. When there is an answer from the card company which answer indicates that the credit card is unusable, the electronic commerce server 2 accepts the order but sets the order in a state of incomplete settlement, and prompts the orderer to make payment by another card or another method of settlement. When there is an answer from the card company which answer indicates that the credit card is usable, on the other hand, the electronic commerce server 2 accepts the order, and transmits received order data to the store server 3. However, as described earlier, even when a fraudulent credit card is used, an answer indicating that the credit card is usable is given in the authorization unless the card company has registered the credit card as an unusable credit card. Accordingly, the monitoring assistance device 1 according to the present embodiment assists a monitoring person in monitoring suspicious orders not detected in such authorization.

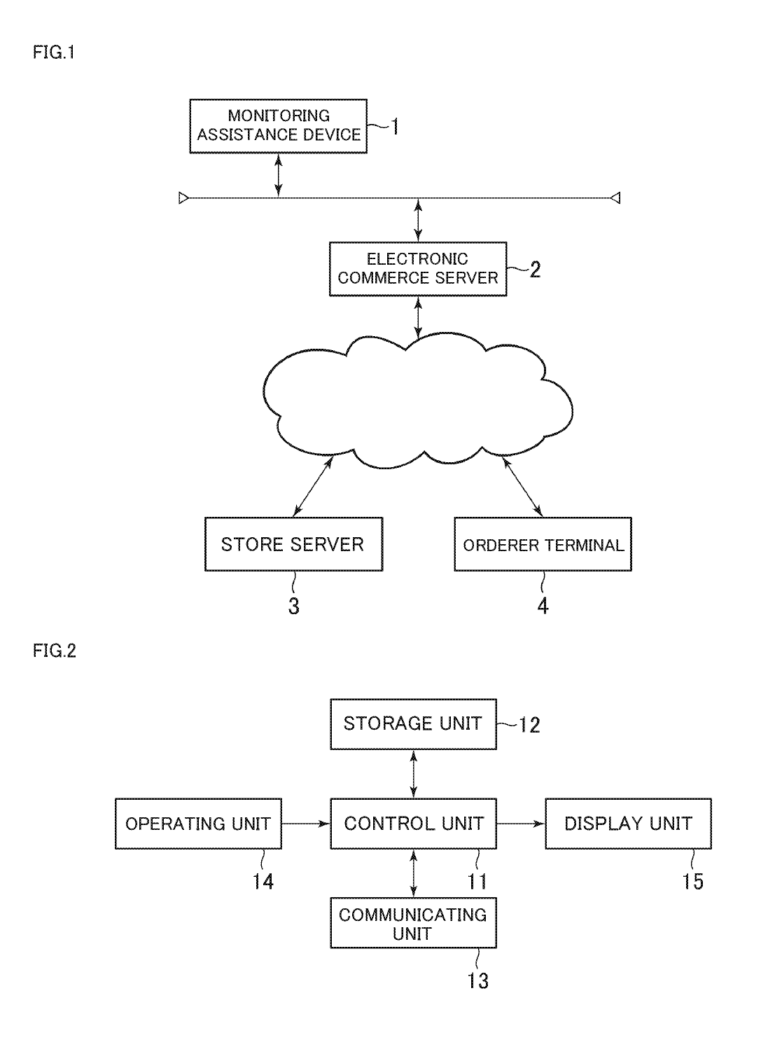

The monitoring assistance device 1 is a computer used to monitor the contents of orders received by the electronic commerce server 2. As shown in FIG. 2, the monitoring assistance device 1 includes a control unit 11, a storage unit 12, a communicating unit 13, an operating unit 14, and a display unit 15.

The control unit 11 includes a CPU (Central Processing Unit) or the like. The control unit 11 performs various kinds of information processing according to a program stored in the storage unit 12. Details of processing performed by the control unit 11 in the present embodiment will be described later. The storage unit 12 includes a memory element such as a RAM (Random Access Memory) and a disk device such as a hard disk. The storage unit 12 stores the program executed by the control unit 11 and data to be processed by the program.

The communicating unit 13 is a communication interface such as a LAN (Local Area Network) card. The communicating unit 13 transmits and receives information via a communication network. The communicating unit 13 in the present embodiment receives received order data in electronic commerce from the electronic commerce server 2 via a communication network such as a LAN.

The operating unit 14 is a mouse, a keyboard, and the like. The operating unit 14 receives an operating input by a user, and outputs a signal indicating the contents of the operation to the control unit 11. The display unit 15 is a liquid crystal display or the like. The display unit 15 displays various kinds of information on a screen according to an instruction of the control unit 11.

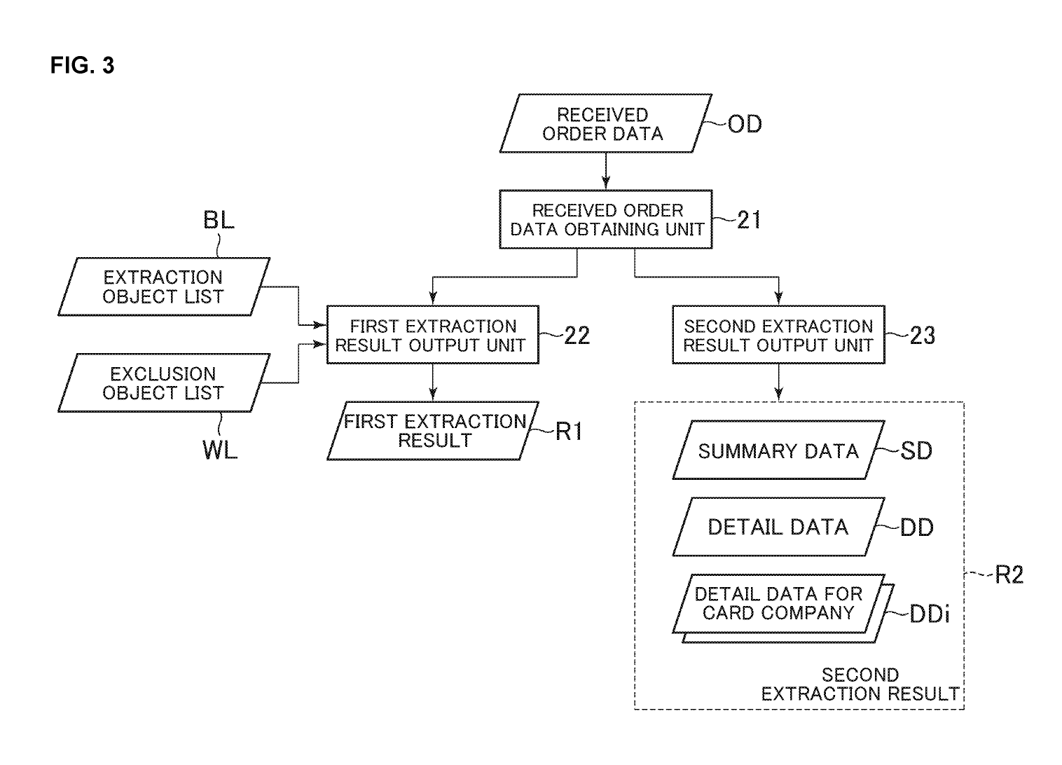

As shown in FIG. 3, the monitoring assistance device 1 according to the present embodiment functionally includes a received order data obtaining unit 21, a first extraction result output unit 22, and a second extraction result output unit 23. These functions are implemented by the control unit 11 by executing the program stored in the storage unit 12. This program may be provided to the monitoring assistance device 1 in a state of being stored on an information storage medium such as an optical disk, or may be provided to the monitoring assistance device 1 via a communication network such as the Internet.

The received order data obtaining unit 21 obtains received order data OD from the electronic commerce server 2. The received order data OD includes a plurality of records. Each record represents the contents of one order received by the electronic commerce server 2. In the present embodiment, in particular, each record of the received order data OD corresponds to one kind of product. Therefore, when an orderer orders three kinds of products at a time, for example, the electronic commerce server 2 generates three records representing the contents of three orders corresponding to the three kinds of products.

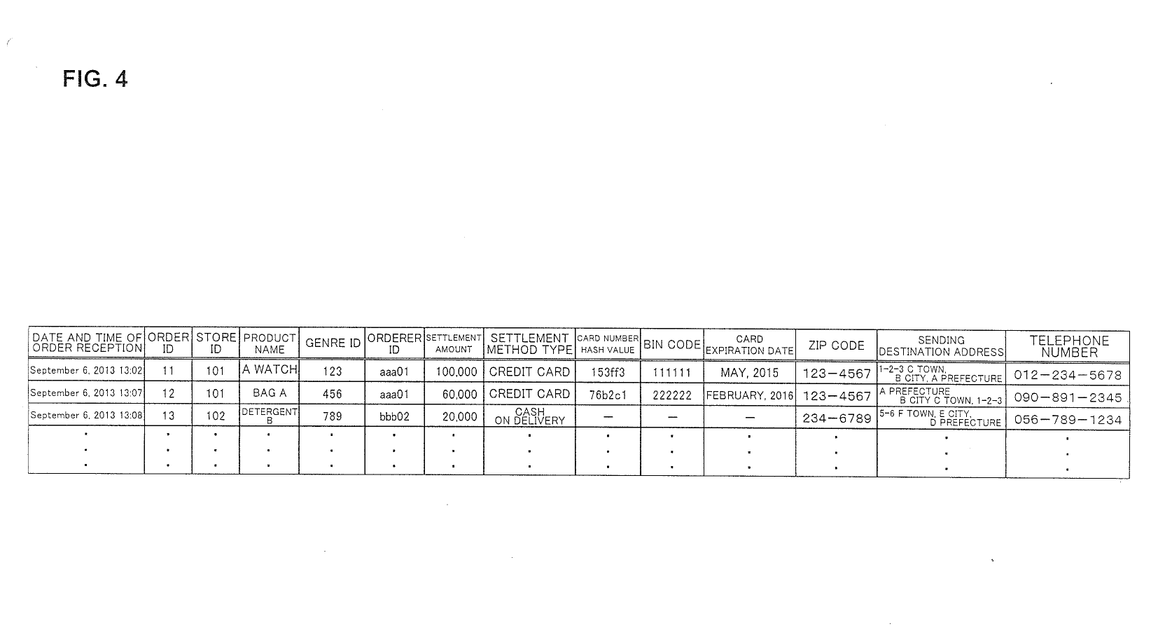

FIG. 4 is a diagram showing an example of a data structure of the received order data OD. In the example of the figure, the received order data OD includes respective fields of an order reception date and time, an order ID (Identification), a store ID, a product name, a genre ID, an orderer ID, and a settlement amount. The received order data OD also includes a field storing information about a method of settlement and a field storing information about the sending destination of the product.

The order ID is information for uniquely identifying an order, the information being assigned to each record. The store ID is information identifying a store that received the order. The genre ID is information identifying the genre (category) of the ordered product. The orderer ID is information for uniquely identifying an orderer. The orderer ID is an ID obtained by each orderer in advance to use the electronic commerce server 2. The orderer orders the product in a state of being authenticated by the electronic commerce server 2 on the basis of the orderer ID.

The received order data OD includes a settlement method type (credit card, cash on delivery, bank transfer, or the like) as a field related to a method of settlement, and further includes fields storing information about a credit card used in a case where the settlement method type is credit card. Fields of a card number hash value, a BIN (Bank Identification Number) code, and an expiration date are cited as the fields storing information about the credit card. The card number hash value is a value calculated by a hash function on the basis of a card number. The BIN code is code information identifying a credit card company, the code information being included in high-order digits of the card number.

In addition, the received order data OD includes one or more fields indicating information for identifying the sending destination of the product (sending destination information). The sending destination information includes at least character string information identifying the address of the sending destination of the product. The sending destination information may also include information about a zip code, a telephone number, the name of the orderer, and the like. In the example of FIG. 4, the received order data OD includes fields of the zip code, the sending destination address, and the telephone number as the sending destination information.

It is to be noted that FIG. 4 is merely an example of the data structure of the received order data OD. The received order data OD may also include various other kinds of data items. In addition, information included in one field in FIG. 4 may be divided and stored in a plurality of subdivided fields. Specifically, for example, the zip code may be divided into a field storing high-order digits and a field storing low-order digits. In addition, the sending destination address may be divided into fields each storing a prefecture, a municipality, a town area, and the like.

The electronic commerce server 2 transmits the received order data OD indicating the contents of orders newly received after a previous transmission to the monitoring assistance device 1 at an arbitrary frequency, for example at intervals of M (M is a natural number of 10 or less) hours. The received order data obtaining unit 21 stores the received order data OD thus received from the electronic commerce server 2 in the storage unit 12. The received order data OD is accumulated in the storage unit 12 over a predetermined period.

The first extraction result output unit 22 extracts a record that is likely to represent a fraudulent order from the received order data OD obtained by the received order data obtaining unit 21, and outputs the extracted record as a first extraction result R1. Processing in which the first extraction result output unit 22 outputs the first extraction result R1 will hereinafter be referred to as first extraction processing. In addition, the record determined to be likely to represent a fraudulent order and included in the first extraction result R1 will be referred to as a first extracted record.

In the present embodiment, suppose that a monitoring person (operator) visually monitors the contents of the first extraction result R1. As a concrete example, the first extraction result output unit 22 displays the contents of the first extracted record on the display unit 15. The monitoring person visually checks the contents of the first extracted record displayed on the display unit 15, and performs an operation of canceling the order when determining that the order is actually a fraudulent order. Information on the record of the canceled order is stored as a canceled record in a canceled order log retained within the storage unit 12.

The first extraction result output unit 22 performs the first extraction processing at a predetermined first frequency. This first frequency is higher than a frequency at which the second extraction result output unit 23 to be described later performs second extraction processing. This is to find a fraudulent order at an early stage as a result of performing the first extraction processing at relatively short time intervals and the monitoring person monitoring a result of the processing. The first extraction processing output unit 22 performs, at the first frequency, the first extraction processing in which records of received order data OD received within a corresponding period are set as a processing object. For example, each time received order data OD for M hours is transmitted from the electronic commerce server 2, the first extraction result output unit 22 performs the first extraction processing in which the received order data OD for the past M hours is set as a processing object. Incidentally, while the first frequency in this case is regular time intervals, the first extraction result output unit 22 may perform the first extraction processing at an irregular frequency. Specifically, for example, the first extraction result output unit 22 may perform the first extraction processing each time received order data OD of a predetermined number of orders is transmitted from the electronic commerce server 2. In either case, by repeatedly performing the first extraction processing in which records of orders received after records set as a processing object a previous time are set as a processing object, the first extraction result output unit 22 can perform the first extraction processing on records of all orders received by the electronic commerce server 2.

A concrete example of the first extraction processing will be described in the following. The first extraction processing is processing of comparing the contents of a record as a processing object (which record will hereinafter be referred to as a comparison object record) with an extraction object list BL prepared in advance, and outputting the comparison object record as a first extraction result R1 when the comparison object record satisfies a predetermined first extraction condition as a result of the comparison. The extraction object list BL is a so-called blacklist, and includes information about orders determined to be suspicious in the past.

Specifically, in the present embodiment, suppose that the extraction object list BL includes a plurality of pieces of sending destination information used in orders determined to be suspicious in the past. FIG. 5 shows an example of the extraction object list BL. The first extraction result output unit 22 compares the product sending destination information included in the comparison object record with each of the pieces of sending destination information included in the extraction object list BL, and adds the comparison object record as a first extracted record to the first extraction result R1 when determining that the two pieces of sending destination information correspond to each other. Incidentally, the sending destination information of the comparison object record and the sending destination information in the extraction object list BL do not necessarily need to completely coincide with each other. The first extraction result output unit 22 may determine that the two pieces of sending destination information correspond to each other when the two pieces of sending destination information are similar to each other to a certain extent. This is because a person intending to place a fraudulent order may try to evade monitoring by for example slightly changing the notation of the address from that used in the past on purpose.

The following description will be made of a few concrete examples of processing in which the first extraction result output unit 22 compares two pieces of sending destination information with each other. For example, the first extraction result output unit 22 may compare a character string included in one or more fields forming the sending destination information in the comparison object record with a character string of sending destination information included in the extraction object list, and may determine that the two character strings correspond to each other when the number of characters not coinciding with each other is a predetermined number or less. Alternatively, it may be determined that the two character strings correspond to each other when a number of characters representing a predetermined ratio or more to the number of characters of the whole of the character strings as comparison objects coincide with each other. A field used as a comparison object in this case may be only a sending destination address, for example, or a combination of fields selected from a zip code, a sending destination address, a telephone number, the name of an orderer, and the like may be used as a comparison object. In addition, only a part of the sending destination address may be used as a comparison object. For example, the first extraction result output unit 22 may set, as a comparison object, a combination of the zip code and a portion of the sending destination address, the portion being obtained by removing information known from the zip code, such as a prefecture, a municipality, and a town area, from the sending destination address.

In addition, the first extraction result output unit 22 may make the comparison using particular characters extracted from the sending destination information. As a concrete example, the first extraction result output unit 22 extracts a number included in the fields of the zip code and the sending destination address of the comparison object record. The first extraction result output unit 22 similarly extracts a number from sending destination information included in the extraction object list BL. The first extraction result output unit 22 then compares a character string formed by the number extracted from the comparison object record with a character string formed by the number extracted from the extraction object list BL. When the two character strings correspond to each other as a result of the comparison, the first extraction result output unit 22 extracts the comparison object record as a first extracted record. Incidentally, also in this case, the comparison object record may be extracted as a first extracted record when the character strings formed by the extracted numbers do not completely coincide with each other but the two character strings are similar to each other within a range of a predetermined condition. Even if a fraudulent orderer changes the notation of the address, an erroneous delivery may occur when a number used as a house number, a room number, or the like is changed. There is thus a strong possibility of these numbers not being changed. Accordingly, by extracting only a number from a particular field forming the sending destination information and comparing the number, it is possible to determine accurately whether or not the sending destination information of the product corresponds to sending destination information in the extraction object list BL. Thus, a possibility of the first extraction result output unit 22 being able to detect such an order is increased even if a fraudulent orderer places an order after changing the notation of the address. Therefore failures to detect fraudulent orders can be reduced.

A concrete example of processing of comparing sending destination information using such a numerical string will be described by taking as an example a case where the sending destination information is constituted of fields of a “zip code,” a “prefecture,” a “municipality,” and an “address.” Suppose in this case that the sending destination information of the comparison object record is a zip code “803-0862,” a prefecture “FUKUOKAJAPAN,” a municipality “KITAKYUSHU,” and an address “1-2-3 ooo Town, Kokurakita Ward, Kitakyushu City, Fukuoka Prefecture,” and sending destination information in the extraction object list BL is a zip code “803-0862,” a prefecture “Fukuoka Prefecture,” a municipality “Kokurakita Ward, Kitakyushu City,” and an address “1-2-3 ooo Town.” The present example assumes that the fraudulent orderer changes the external form of the notation of the same address by mixing Roman characters with Japanese characters and making the input fields different. In this case, the first extraction result output unit 22 generates a character string “8030862-123,” for example, by extracting the numbers from the sending destination information included in the comparison object record. Incidentally, in this case, “-” is used as a delimiter for separating the numbers extracted from the fields different from each other. Similarly, a character string “8030862-123” is obtained when numbers are extracted from the sending destination information included in the extraction object list BL. These character strings coincide with each other. The first extraction result output unit 22 therefore determines that the two character strings correspond to each other. Thus, even when the fraudulent orderer changes a part of the notation of the address, it is possible to determine that practically the same sending destinations correspond to each other by comparing the extracted numbers with each other. Incidentally, the first extraction result output unit 22 may set only Arabic numerals as extraction objects, and may include also Chinese numerals in extraction objects. In addition, in a case where Chinese numerals are extracted, comparison may be made after all of the extracted Chinese numerals are converted into Arabic numerals. This makes it possible to determine correctly whether or not the two character strings correspond to each other even when the fraudulent orderer uses different kinds of numerals, that is, Chinese numerals and Arabic numerals.

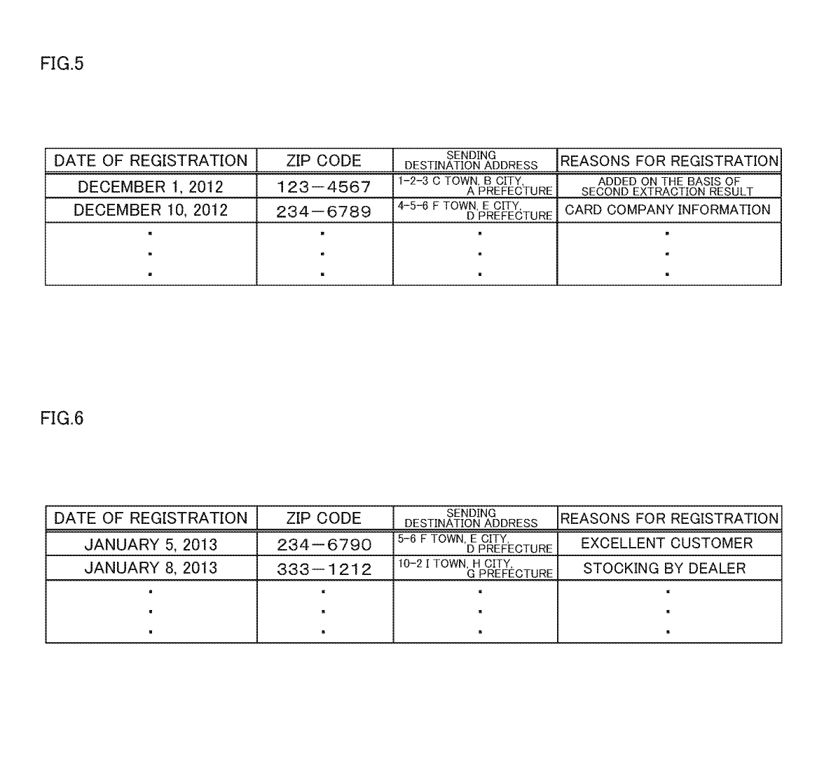

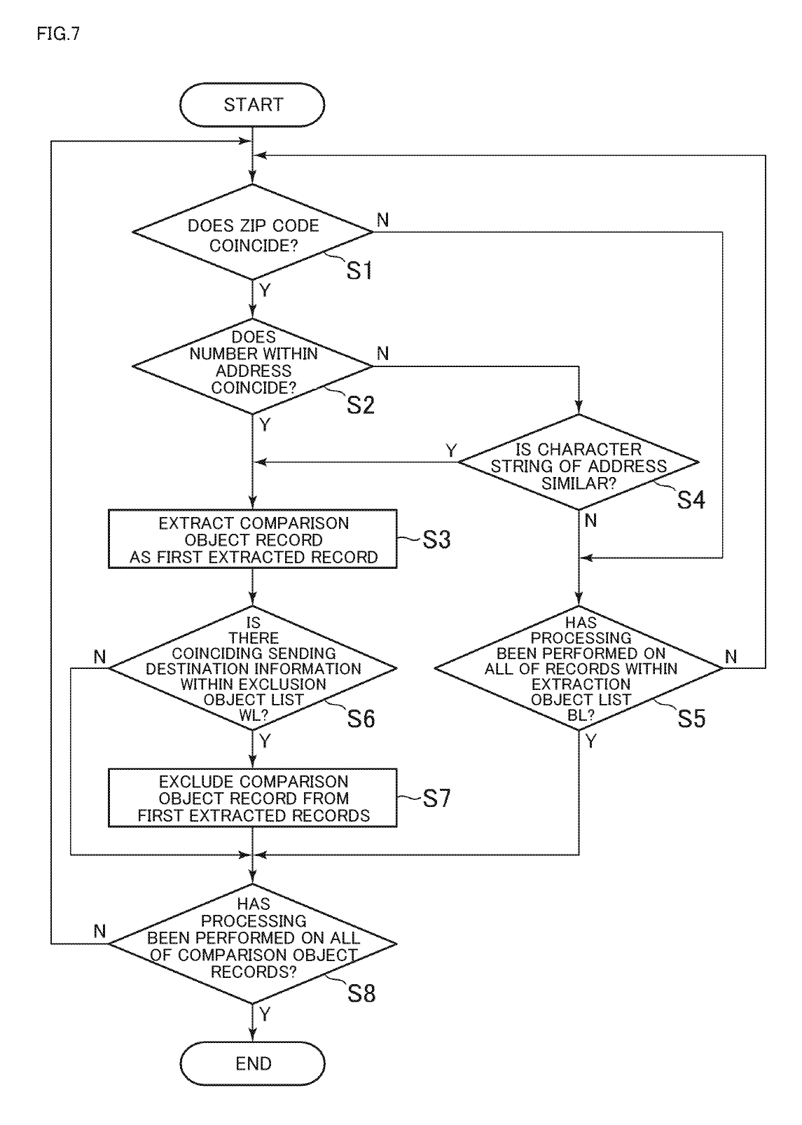

In the above description, the first extraction result output unit 22 compares the comparison object record with the extraction object list BL under a relatively loose extraction condition, and adds the comparison object record to the first extraction result R1 when the sending destination information of the comparison object record and sending destination information in the extraction object list BL are similar to each other with a certain degree of similarity. Therefore, an order including, as a sending destination, an address that is not questionable and is actually different from sending destinations included in the extraction object list BL may be extracted as a first extracted record. Accordingly, the first extraction result output unit 22 may further compare, with an exclusion object list WL prepared in advance, the comparison object record determined to satisfy the predetermined first extraction condition as a result of the comparison with the extraction object list BL. The exclusion object list WL is a so-called white list, and includes a plurality of pieces of sending destination information determined to be safe from actual purchase results in the past or the like. FIG. 6 shows an example of the contents of the exclusion object list WL. In the example of the figure, the exclusion object list WL has a data format similar to that of the extraction object list BL of FIG. 5, and includes a plurality of pieces of sending destination information determined to be safe.

When determining as a result of the comparison with the exclusion object list WL that the sending destination information included in the comparison object record corresponds to sending destination information included in the exclusion object list WL, the first extraction result output unit 22 excludes the comparison object record from the first extraction result R1. Incidentally, a condition for determining that the sending destination information of the comparison object record and the sending destination information in the exclusion object list WL correspond to each other at the time of the comparison may be stricter than the determination condition at the time of the comparison using sending destination information in the extraction object list BL. As a concrete example, the first extraction result output unit 22 excludes the comparison object record from the first extraction result R1 only when the sending destination information of the comparison object record and the sending destination information in the exclusion object list WL completely coincide with each other. This is because it is considered that an ordinary user without a fraudulent intention does not slightly change the notation of the same address.

For example, in FIG. 5 and FIG. 6, the extraction object list BL includes a sending destination address “4-5-6 F Town, E City, D Prefecture,” and the exclusion object list WL includes a sending destination address “5-6 F Town, E City, D Prefecture.” Even if the sending destination address of the comparison object record is “5-6 F Town, E City, D Prefecture,” and the sending destination address is determined to be similar to “4-5-6 F Town, E City, D Prefecture” in the extraction object list BL, the sending destination address is ultimately excluded from the first extraction result R1 because the sending destination address completely coincides with the sending destination address in the exclusion object list WL.

Incidentally, the comparison with the exclusion object list WL may be made prior to the comparison with the extraction object list BL. In this case, the first extraction result output unit 22 compares only comparison object records whose sending destination information is determined not to correspond to sending destination information included in the exclusion object list WL with the sending destination information included in the extraction object list BL, and outputs the first extraction result R1. By combining the comparison using the extraction object list BL with the comparison using the exclusion object list WL when extracting order information, as described above, it is possible to reduce an amount of data to be monitored by the monitoring person, and thus reduce a load on the monitoring person. Further, by relatively loosening determination criteria for filtering by comparison with the extraction object list BL, it is possible to detect a wide range of intentional address alterations by a fraudulent orderer.

A concrete example of a flow of the whole of the first extraction processing performed by the first extraction result output unit 22 at the first frequency will be described in the following with reference to a flowchart of FIG. 7. At intervals of M hours, for example, the first extraction result output unit 22 performs the following processing in which records of orders received during a period from after a previous time of performing the first extraction processing to a start of a present time of performing the first extraction processing are set as comparison object records.

First, the first extraction result output unit 22 compares one comparison object record as a processing object with sending destination information included in a record of interest within the extraction object list BL. Specifically, the first extraction result output unit 22 determines whether or not a zip code of the comparison object record coincides with a zip code included in the record of interest in the extraction object list BL (S1). When the two zip codes do not coincide with each other, it is determined that the sending destination information of the comparison object record and the sending destination information of the record of interest do not correspond to each other. The first extraction result output unit 22 therefore proceeds to processing of S5. When it is determined that the zip codes coincide with each other, on the other hand, the first extraction result output unit 22 further determines whether or not a character string formed by a number extracted from a sending destination address included in the comparison object record coincides with a character string formed by a number extracted from a sending destination address included in the record of interest (S2). When determining that the two character strings coincide with each other, the first extraction result output unit 22 determines that the sending destination information of the comparison object record and the sending destination information included in the record of interest correspond to each other, and extracts the comparison object record as a first extracted record (S3). When the two character strings do not coincide with each other, on the other hand, the first extraction result output unit 22 further determines whether or not the character string of the sending destination address of the comparison object record and the character string of the sending destination address included in the record of interest are similar to each other with a degree of similarity that is equal to or more than a predetermined threshold value (S4). When there is a difference between the included numerical strings, but the character strings of the sending destination addresses as a whole are similar to each other with a degree of similarity that is equal to or more than the predetermined threshold value, the first extraction result output unit 22 determines that the two character strings correspond to each other, and extracts the comparison object record as a first extracted record (S3). When determining that the sending destination address of the comparison object record and the sending destination address of the record of interest are not similar to each other, on the other hand, the first extraction result output unit 22 proceeds to the processing of S5. Incidentally, it is already known that the zip codes themselves coincide with each other when the degree of similarity is determined in S4. Thus, parts corresponding to the zip code (parts of a prefecture, a municipality, and a town area) in the character strings of the addresses may be excluded, and the degree of similarity between only the remaining parts may be evaluated.

When the zip codes do not coincide with each other in S1, and when it is determined that the sending destination addresses are not similar to each other in S4, the first extraction result output unit 22 determines whether or not the processing has been performed on all of the records included in the extraction object list BL (S5). When there is an unprocessed record that has not yet been compared with the comparison object record within the extraction object list BL, the first extraction result output unit 22 sets the unprocessed record as a new record of interest, and returns to S1 to compare the new record of interest with the comparison object record. When all of the records are set as the record of interest, and the comparison is ended, it is determined that this comparison object record is not set as an extraction object. The first extraction result output unit 22 therefore proceeds to processing of S8.

When extracting the comparison object record as the first extracted record in S3, on the other hand, the first extraction result output unit 22 determines whether or not the sending destination information of the comparison object record coincides with one of the pieces of sending destination information included within the exclusion object list WL (S6). When there is coinciding sending destination information within the exclusion object list WL, the first extraction result output unit 22 excludes the comparison object record once extracted in S3 from first extracted records (S7). The first extraction result output unit 22 then proceeds to the processing of S8. When there is no coinciding sending destination information within the exclusion object list WL, the first extraction result output unit 22 retains the comparison object record as the first extracted record as it is. The first extraction result output unit 22 then proceeds to the processing of S8.

The processing thus far has determined whether or not to extract one comparison object record as a first extracted record by comparison with the extraction object list BL and the exclusion object list WL. Accordingly, the first extraction result output unit 22 determines whether or not the processing has been performed on all of the comparison object records (S8). When there is an unprocessed comparison object record, the first extraction result output unit 22 performs the processing from S1 to S7 again on the unprocessed comparison object record. After thus performing the processing on all of the comparison object records, the first extraction result output unit 22 ends the first extraction processing.

Incidentally, the first extraction result output unit 22 may determine whether or not to add the comparison object record to the first extraction result R1 by not only using the conditions related to the result of comparison with the extraction object list BL but also combining another condition. Specifically, for example, the first extraction result output unit 22 may include only orders whose settlement amounts are equal to or more than a predetermined amount in the first extraction result R1. In addition, orders for particular products that tend to be targeted for fraudulent orders or a particular genre of products may be added to the first extraction result R1. In addition, orders satisfying a predetermined condition in relation to a settlement method type (settlement by using points or the like), order reception dates and times (orders in a particular time period or the like), or the like may be set as extraction objects. In addition, the extraction object list BL may include not only sending destination information used in suspicious orders but also orderer IDs used in the suspicious orders or the like. Also in this case, the first extraction result output unit 22 can output a comparison object record corresponding to a suspicious order as a first extracted record by comparing information included in the extraction object list BL with information in the corresponding field of the comparison object record.

In addition, the first extraction result output unit 22 may output the first extraction result R1 after sorting first extracted records according to a predetermined criterion. For example, the first extraction result output unit 22 outputs the first extraction result R1 after sorting in decreasing order of the degrees of similarity (ratio of the number of coinciding characters or the like) between sending destination information included in the comparison object records and sending destination information included in the extraction object list BL. This can facilitate monitoring work by the monitoring person.

The first extraction processing described above can extract a comparison object record likely to represent a fraudulent order by comparing the comparison object record with the extraction object list BL including information about orders determined to be suspicious in the past. In particular, even if a fraudulent orderer repeats a fraudulent order while changing the payment method or the orderer ID, making comparison with the sending destination information included in the extraction object list BL can detect such an order when the fraudulent orderer intends to receive products at a same location. However, the first extraction processing can detect only orders similar to orders whose problems have been actually detected in the past. Accordingly, in the present embodiment, the second extraction result output unit 23 to be described in the following extracts information for assisting in monitoring fraudulent orders by a method different from the first extraction processing.

The second extraction result output unit 23 performs aggregation processing using received order data OD in a predetermined period which data is obtained by the received order data obtaining unit 21, and outputs a result of the aggregation as a second extraction result R2. Specifically, the second extraction result output unit 23 performs the aggregation processing on records of a plurality of orders received within a predetermined period in the past (which records will hereinafter be referred to as aggregation object records), and outputs resulting information as the second extraction result R2. The processing in which the second extraction result output unit 23 aggregates the aggregation object records and outputs the second extraction result R2 will hereinafter be referred to as second extraction processing. As with the first extraction result R1, the second extraction result R2 may also be visually monitored by the monitoring person.

The second extraction result output unit 23 performs the second extraction processing at a second frequency lower than the first frequency. The second extraction processing is intended to detect suspicious orders by aggregating a plurality of records received over a predetermined period. Thus, unless a certain number of orders are newly received after a previous time of performing the second extraction processing, there is little necessity for performing the second extraction processing next time. Incidentally, aggregation object records as an object of the second extraction processing may be received over a period longer than a time interval of the second frequency. For example, the second extraction result output unit 23 performs the second extraction processing on aggregation object records received during a period of past N (N is a natural number of 2 or more) days at intervals of one day. In this case, aggregation object records for remaining (N−1) days which aggregation object records are obtained by excluding aggregation object records for one nearest day from aggregation object records for N days as an object of the second extraction processing overlap aggregation object records in the previous time of the second extraction processing. When aggregation object records in a relatively long period are thus set as a processing object, suspicious orders that cannot be found from only orders received in a short period can be expected to be detected.

Specific details of the second extraction processing will hereinafter be described. The second extraction processing is processing of aggregating aggregation object records with a predetermined field as a key. Here, the second extraction result output unit 23 may also perform the aggregation processing with a combination of a plurality of fields as a key. Suppose in the following that the second extraction result output unit 23 performs aggregation using, as a key, a plurality of fields (for example fields of the zip code and the sending destination address) forming sending destination information. Thus, when a plurality of orders whose sending destinations correspond to each other are received within an aggregation object period, the presence of such orders can be detected. Incidentally, when performing aggregation using sending destination information as a key, the second extraction result output unit 23 may perform aggregation assuming that pieces of sending destination information determined to be similar to each other on the basis of a predetermined condition correspond to each other as in the first extraction processing described above, rather than aggregating only aggregation object records whose pieces of sending destination information completely coincide with each other.

Further, the second extraction result output unit 23 outputs, as a second extraction result R2, information about orders satisfying a predetermined second extraction condition in an aggregation result obtained by aggregating aggregation object records using sending destination information as a key. Specifically, when there are a plurality of orders whose sending destinations correspond to each other, the second extraction result output unit 23 determines whether or not values in a field of interest of aggregation object records of the plurality of orders satisfy the predetermined second extraction condition. Then, when it is determined that the second extraction condition is satisfied, information about the plurality of aggregation object records is included in the second extraction result R2. Here, the field of interest is a field as an object of determination according to the second extraction condition among fields included in the aggregation object records. There may be a plurality of fields of interest. The second extraction condition in this case may be a condition to be satisfied by a numerical value obtained by performing statistical processing on the values in the field of interest included in the plurality of aggregation object records having pieces of sending destination information corresponding to each other. The statistical processing in this case may be for example processing of calculating one of a maximum value, a minimum value, a total value, and an average value of the values in the field of interest, or may be processing of counting the number of pieces of data included in the field of interest excluding duplications.

As an example, using the card number hash value of a credit card as a field of interest, the second extraction result output unit 23 counts the number of card number hash values in a plurality of aggregation object records whose pieces of sending destination information correspond to each other. Then, when the counted number of the card number hash values that are not mutually duplicated is a predetermined number or more, information about these aggregation object records is included in the second extraction result R2. The number of the card number hash values in this case indicates the number of credit cards used in a plurality of orders having a same address as a sending destination. Generally, it can be considered that one orderer places a large number of orders using a same address as a sending destination. However, at most a few credit cards or so are used in that case, and it is difficult to expect that a large number of different credit cards are used for respective orders. Thus, there may be a possibility of attempts to make fraudulent transactions when the number of the card number hash values in a plurality of orders whose pieces of sending destination information correspond to each other is a predetermined number or more. Accordingly, when there are a plurality of aggregation object records whose pieces of sending destination information correspond to each other and whose number of card number hash values is a predetermined number or more, the second extraction result output unit 23 includes information about such aggregation object records in the second extraction result R2.

Incidentally, the second extraction result output unit 23 may generate the second extraction result R2 using not only the sending destination information but also various kinds of fields as an aggregation key. A field preferable as an aggregation key in this case is a field including information that can identify an orderer such for example as an orderer ID. A plurality of orders including a common orderer ID can be determined as orders placed by a same orderer. Thus, when a large number of credit cards are used in the orders, the orders can be considered to be suspicious orders. In addition, when the received order data OD includes information that can identify the orderer terminal 4 (for example an IP (Internet Protocol) address, a MAC (Media Access Control) address, cookie information of a browser, or the like), the aggregation processing may be performed using such information as a key.

In addition, the second extraction result output unit 23 may use, as fields of interest, not only credit card numbers but also various kinds of fields. Specifically, for example, the name or the orderer ID of an orderer may be used as a field of interest. Also in the case of these data items, the number of the data items used with a same sending destination is generally assumed to be limited. Thus, when the number of data items included in the field of interest is a predetermined number or more, the aggregation result is added to the second extraction result R2. Thereby suspicious orders can be extracted. In addition, whether or not to include information about aggregation object records in the second extraction result R2 may be determined using settlement amounts as a field of interest and a total value of the settlement amounts as a result of statistical processing on the settlement amounts. This is because even if a settlement amount in each order is a relatively small amount, there is a possibility of suspicious orders when the sum of the settlement amounts is a large amount. In addition, whether or not to include information about aggregation object records in the second extraction result R2 may be determined on the basis of a result of counting the number of orders themselves, the number of kinds of products, or the like. In addition, when a field other than the sending destination information, such as the orderer ID, is used as an aggregation key, whether or not the number of pieces of the sending destination information is a predetermined number or more may be set as the second extraction condition.

Further, the second extraction result output unit 23 may change the second extraction condition for determining whether or not to include information about aggregation object records in the second extraction result R2 according to a record value as a key. As a concrete example, when the second extraction result R2 is extracted using the orderer ID as an aggregation key, and using, as a field of interest, the number of orders, settlement amounts, the number of pieces of sending destination information, the number of kinds of products, and the like, a threshold value for the number of orders or the settlement amounts is changed for each orderer ID. The threshold value of each orderer ID in this case may be calculated from a history of orders placed using the orderer ID in a predetermined period in the past. For example, an average value of settlement amounts per period of N days is calculated for each orderer ID by aggregating order histories during the past year, and an amount obtained by multiplying the average value by a predetermined coefficient is set as the threshold value for settlement amounts. Then, when a total value of settlement amounts aggregated for each orderer ID exceeds the threshold value set for the orderer ID at a time of performing the second extraction processing, the aggregation result of the orderer ID is included in the second extraction result R2. Thus, in a case where each orderer places orders having a tendency different from a tendency estimated from a history of orders in the past, such for example as a case where the orderer places orders in a concentrated manner during nearest N days, the orders amounting to a sum greatly exceeding an average purchase sum in the past, information about such orders can be extracted. By setting the threshold value to be a value different for each orderer ID in this case, it is possible to determine whether or not to add information about aggregation object records to the second extraction result R2 on the basis of a determination criterion adjusted to the purchase tendency of each orderer.

The second extraction result R2 includes summary data SD and detail data DD. The summary data SD is data representing a result of extraction performed by applying the second extraction condition to an aggregation result. The summary data SD includes a plurality of summary records each corresponding to one piece of sending destination information. Each summary record represents results of performing statistical processing on fields of interest in a plurality of aggregation object records whose pieces of sending destination information correspond to each other. Each summary record includes sending destination information and numerical values indicating the results of the statistical processing.

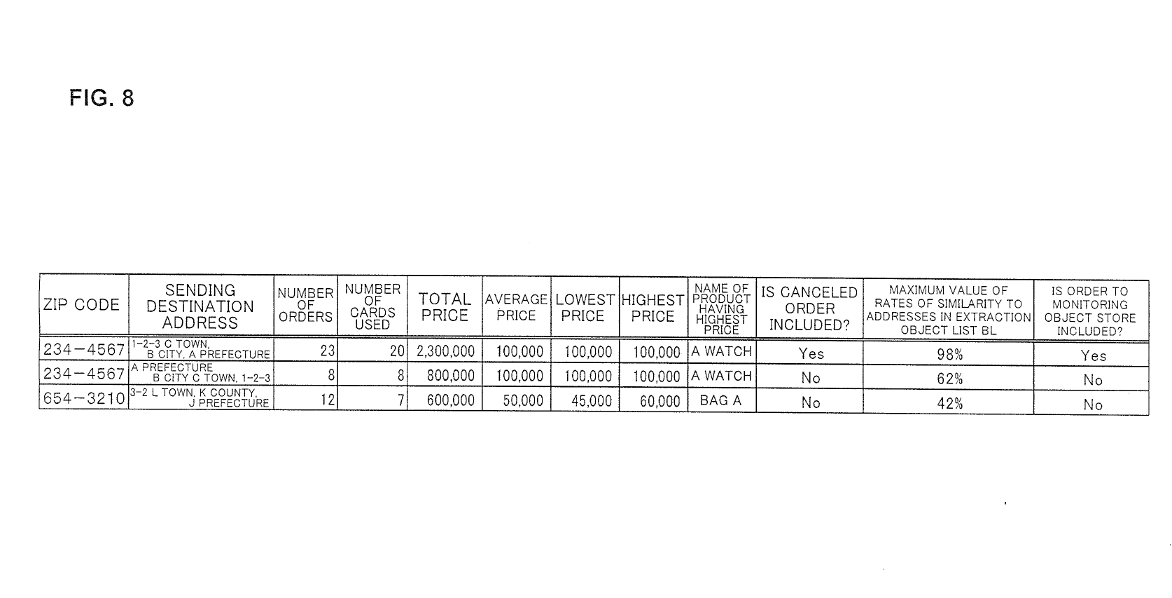

FIG. 8 shows an example of the summary data SD. In the example of FIG. 8, card number hash values are set as one of the fields of interest, and the number of the card number hash values is included as the “number of cards used” in the summary data SD. A summary record in a first row in FIG. 8, for example, indicates that there are 23 orders having a same sending destination “1-2-3 C Town, B City, A Prefecture” within an aggregation object period and that 20 credit cards are used in the 23 orders. Incidentally, as described earlier, the summary data SD includes only summary records satisfying the second extraction condition. In this case, when the number of credit cards used for a same sending destination is less than a predetermined number, information about orders related to this sending destination information is not added to the summary data SD.

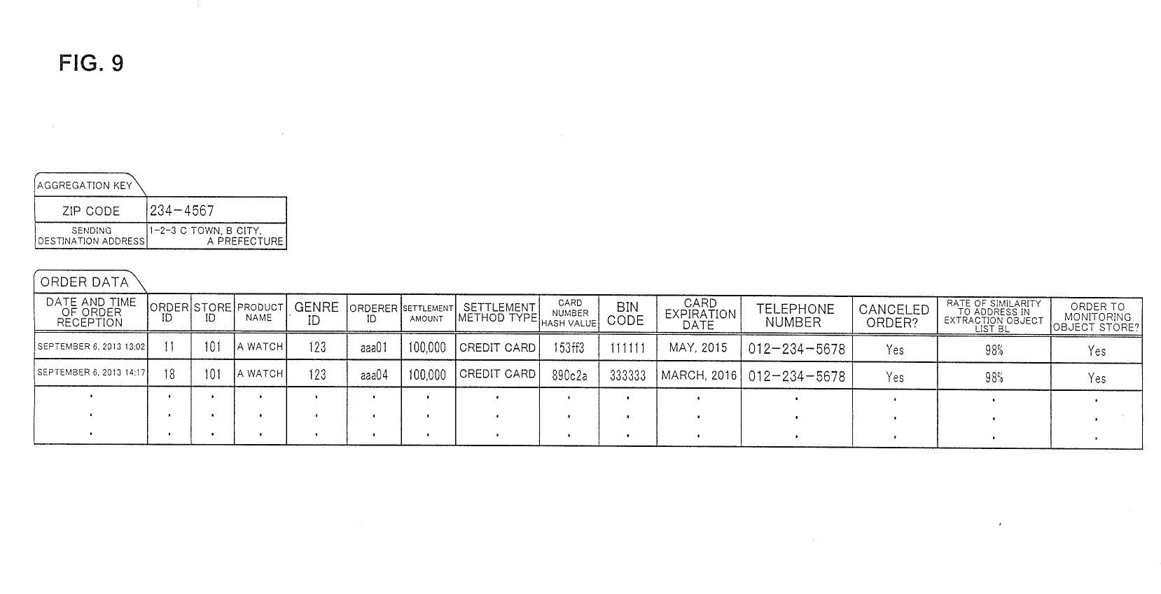

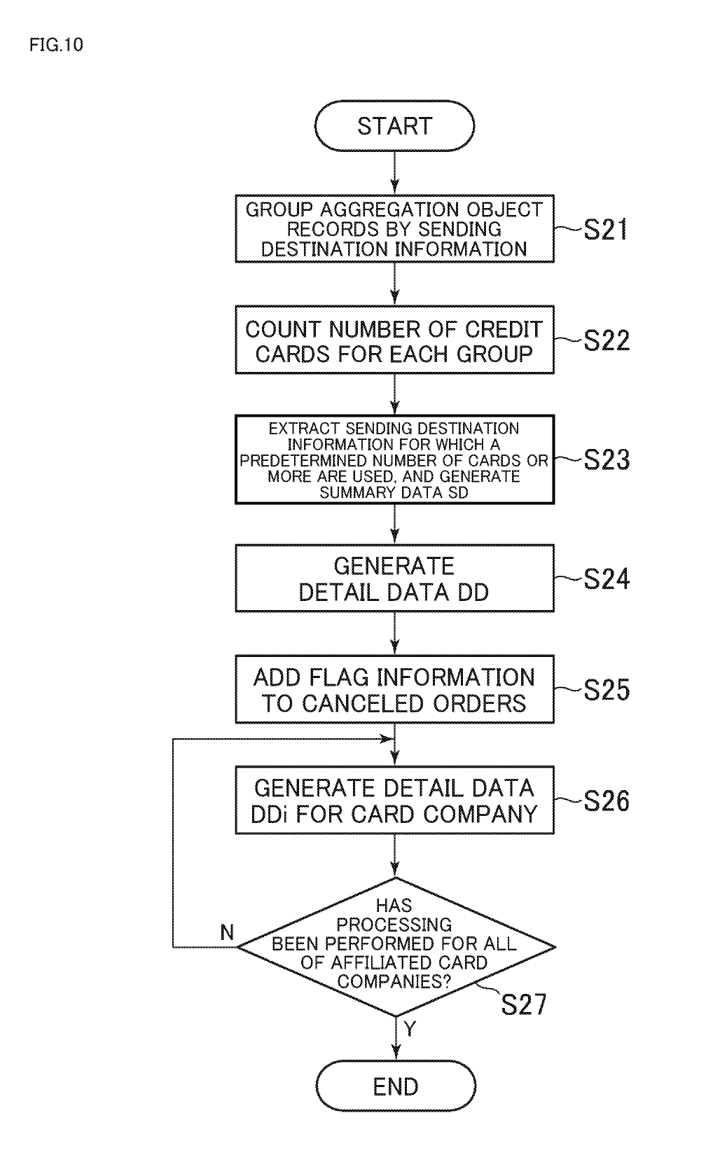

The detail data DD is data representing the contents of aggregation object records included in the summary data SD. In the example of the summary data SD of FIG. 8, for example, the detail data DD is constituted of a total of three tables, that is, a table including 23 aggregation object records corresponding to the record in the first row of the summary data SD, a table including eight aggregation object records corresponding to the record in the second row, and a table including 12 aggregation object records corresponding to the record in the third row. FIG. 9 is a diagram showing an example of contents of the detail data DD, and shows the table corresponding to the summary record in the first row in the summary data SD of FIG. 8. Each aggregation object record included in this detail data DD will hereinafter be referred to as a second extracted record. A second extracted record is a record of an order determined to be likely to be a fraudulent order by the second extraction processing. Incidentally, the detail data DD in this case is constituted of the plurality of tables divided by sending destination information as an aggregation key. However, the detail data DD may be constituted of one table including the contents of orders corresponding to each summary record included in the summary data SD.

The second extraction result output unit 23 may output the detail data DD in such a mode as to enable the monitoring person to grasp supplementary information related to each of the second extracted records included in the detail data DD. For example, the second extraction result output unit 23 outputs the detail data DD in a mode in which a second extracted record meeting a particular condition is distinguishable from a second extracted record not meeting the particular condition. This enables the monitoring person to easily grasp records of orders meeting the particular condition. Concrete examples of a method of outputting the detail data DD in the mode in which a second extracted record meeting the particular condition is distinguishable include a method of adding, to a second extracted record meeting the particular condition, flag information indicating that the second extracted record meets the particular condition, a method of conversely adding, to a second extracted record not meeting the particular condition, flag information indicating that the second extracted record does not meet the particular condition, and the like. Alternatively, the second extraction result output unit 23 may output the detail data DD in a data format in which second extracted records meeting the particular condition are separated from second extracted records not meeting the particular condition.

The following description will be made of a few concrete examples of supplementary information related to the second extracted records within the detail data DD.

The monitoring assistance device 1 performs the first extraction processing and the second extraction processing on the same received order data OD. Therefore, a first extracted record extracted by the first extraction processing may also be extracted as a second extracted record by the second extraction processing. Accordingly, when a second extracted record also corresponds to a first extracted record already extracted by the first extraction processing, the second extraction result output unit 23 may output the detail data DD in a mode that can make a distinction to that effect. Alternatively, when the second extracted record has also been extracted as the first extracted record and further the order related to the second extracted record is actually canceled by the monitoring person, the second extraction result output unit 23 may add information indicating that the order is canceled to the second extracted record. As described earlier, the record which is extracted as the first extracted record by the first extraction processing and in which the order is canceled by an operation of the monitoring person is recorded in the canceled order log. When the second extracted record extracted by the second extraction processing coincides with the record in the canceled order log, the second extraction result output unit 23 outputs this second extracted record in a mode distinguishable from other second extracted records in which the order is not canceled.

In the example of the summary data SD of FIG. 8, each summary record includes information indicating whether or not a canceled order is included. In addition, in the example of the detail data DD of FIG. 9, each second extracted record includes information indicating whether or not the order related to the record is canceled. By referring to these pieces of information, the monitoring person easily compares an order not canceled yet with canceled orders and determines whether or not the order is a suspicious order. As a concrete example, the summary data SD of FIG. 8 indicates that the orders corresponding to the record in the first row include a canceled order, and that the orders corresponding to the record in the second row, on the other hand, do not include a canceled order. In this case, it is assumed that the sending destination address “1-2-3 C Town, B City, A Prefecture” of the record in the first row coincides with the sending destination address in the extraction object list BL in the first extraction processing, and that the order is canceled. In addition, it is assumed that the sending destination address “A Prefecture B City C Town, 1-2-3” of the record in the second row is determined not to be similar to any sending destination address in the extraction object list BL and cannot be detected in the first extraction processing, and that the order is not canceled. In this case, by checking the summary data SD of FIG. 8, the monitoring person can easily determine that the orders corresponding to the record in the second row are strongly suspected to be also fraudulent orders because the sending destination address in the first row in which a suspicious order is canceled is practically the same as the sending destination address in the second row. The monitoring person can therefore deal with such suspicious orders by canceling the orders corresponding to the record in the second row if possible, adding the sending destination address to the extraction object list BL, or reviewing an algorithm for determining similarity of sending destination addresses in the first extraction processing.

In addition, the second extraction result output unit 23 may further compare a second extracted record with the extraction object list BL used in the first extraction processing, and add information about a result of the comparison. As a concrete example, the second extraction result output unit 23 outputs the detail data DD after comparing the sending destination information included in the second extracted record with the sending destination information included in the extraction object list BL, and adding information indicating a result of the comparison to the second extracted record. Further, in this case, the second extraction result output unit 23 may add not only information simply indicating whether or not the two pieces of sending destination information correspond to each other as the result of the comparison but also information indicating a degree of similarity between the two pieces of sending destination information (for example a ratio of the number of characters coinciding with each other between the two pieces of sending destination information to a total number of characters of the two pieces of sending destination information). This information is referred to when the monitoring person determines whether or not the second extracted record represents a really suspicious order.

In addition, the second extraction result output unit 23 may output second extracted records of orders received by predetermined monitoring object stores among the second extracted records included in the detail data DD in a mode distinguishable from second extracted records of orders received by other stores. Stores opened in the electronic mall may include stores that tend to be targeted by fraudulent orderers, such as stores handling expensive products. In addition, there may be a store that has actually received a fraudulent order in the past, and has thereby incurred a credit card chargeback (payment refusal or a refund request from a card issuer to the card member store). Because particular kinds of products tend to be targeted in fraudulent uses, stores that actually incur chargebacks tend to be limited to approximately a few percent of a large number of stores affiliated with the mall type electronic commerce service, for example. Accordingly, such stores are set as monitoring object stores in advance, and the monitoring assistance device 1 stores the store IDs of that stores. The second extraction result output unit 23 compares a store ID included in a second extracted record with the stored store ID of a monitoring object store. When the store IDs coincide with each other, the second extraction result output unit 23 outputs the second extracted record in a mode distinguishable from other records by for example adding flag information indicating that an order is placed with the monitoring object store to the second extracted record. Thereby, the monitoring person can easily grasp orders to stores to which to pay particular attention.

The monitoring person can detect suspicious orders that cannot be found in the first extraction processing by checking the contents of the summary data SD and the detail data DD included in the second extraction result R2 described above. This is because even in a case where it is difficult to determine whether suspicious orders are placed by merely viewing each individual aggregation object record, questionable orders can be extracted when the second extraction result R2 is used, the second extraction result R2 being obtained as a result of aggregating a plurality of aggregation object records.

In addition, the sending destination information included in the summary data SD (that is, the sending destination information of aggregation object records satisfying the second extraction condition) may be newly added to the extraction object list BL used in the first extraction processing. This addition may be automatically performed by the second extraction result output unit 23, or may be performed by the monitoring person by giving instructions individually after checking the second extraction result R2. The processing result of the second extraction processing is thereby reflected in the determination criteria of the first extraction processing. It is therefore possible to improve accuracy of extracting suspicious orders by the first extraction processing. As described earlier, the second extraction processing is performed at a low frequency as compared with the first extraction processing. Thus, even when a suspicious order can be detected by the second extraction processing, the order may be already settled and it may not be possible to cancel the order in time. Even in such a case, new damage can be prevented by reflecting the second extraction result R2 in the extraction object list BL used in the first extraction processing.

Further, the second extraction result output unit 23 may manipulate the second extraction result R2 to provide information to a card company that issues credit cards used in orders. Records indicating the contents of orders using the credit cards of a plurality of card companies are mixed in the detail data DD of the second extraction result R2. It is therefore improper to provide a particular card company with the contents of the detail data DD as they are. Accordingly, the second extraction result output unit 23 generates detail data to be provided to the card company (which detail data will hereinafter be referred to as detail data DDi for the card company), by excluding the contents of aggregation object records of orders not using credit cards of the particular card company as a provision destination from the detail data DD.

Specifically, whether or not the credit cards of the card company as the provision destination are used in orders can be determined by referring to the field of the BIN code included in each aggregation object record. The second extraction result output unit 23 excludes information about other aggregation object records than aggregation object records including the BIN code of the card company as the provision destination from the detail data DD by a method of deleting the other records, a method of substituting a blank or a Null value for data parts to be hidden, or the like. Incidentally, in a case where there are a plurality of provision destination card companies, the processing of generating detail data DDi for the card company from the detail data DD is performed for each of these card companies.

The thus generated detail data DDi for the card company is provided to the card company as the provision destination together with the summary data SD. When the detail data DDi for the card company includes for example only information about one order, and the single order does not seem to be suspicious, the card company as the provision destination can realize that the order is one of orders using a large number of credit cards, by referring to the information in combination with the summary data SD. Therefore, by referring to such information, the card company can realize the suspicious use of credit cards, which use is not known from only information about settlements by credit cards. In particular, sharing the summary data SD and the detail data DDi for the card company with the card company can prompt the card company to take a measure for detecting frauds. The card company can obtain information that would usually be unobtainable, such as a purchased product, an address, or the like tied to the credit card number. It thus becomes easier for the card company to detect fraudulent use of the credit card. The electronic commerce service provider can cancel a suspicious order, but cannot stop the use of the credit card used at the time of the suspicious order. There is thus a fear that even a card number once detected and dealt with by cancellation or the like may be repeatedly used by different methods. Such a problem can be remedied by providing the summary data SD and the detail data DDi for the card company to the card company and prompting the card company to take a measure for detecting frauds. In particular, when the card company stops the use of the credit card used in the fraudulent order, it is possible to cancel the reception of an order in the above-described authorization, and thus reduce a load of monitoring on the part of the electronic mall service provider.

In addition, credit card member stores usually have obligations under a contract with the card company to make efforts to report fraudulent use of a credit card or use of a credit card which use is suspected to be fraudulent to the card company when such use of the credit card occurs. The monitoring assistance device 1 according to the present embodiment reduces a load of reporting on the part of the member stores because the electronic mall service provider on an intermediating side detects suspicious orders and shares information about the suspicious orders with the credit card company on behalf of the member stores. Hence, an electronic mall service more attractive to the member stores is realized.

Incidentally, the monitoring assistance device 1 may also provide the card company with information about orders canceled on the basis of the first extraction result R1. As described earlier, information about orders canceled by the monitoring person after checking the first extraction result R1 is recorded as the canceled order log. Canceled order log data for the card company is generated by extracting orders using credit cards of the card company as the provision destination from the canceled order log. When such log data is provided to the card company as the provision destination, the card company can obtain information about credit cards used for actually canceled orders.

A concrete example of a flow of the whole of the second extraction processing performed by the second extraction result output unit 23 at the second frequency will hereinafter be described with reference to a flowchart of FIG. 10.

First, the second extraction result output unit 23 sorts aggregation object records of orders received in an aggregation object period on the basis of sending destination information as an aggregation key, and thus groups aggregation object records whose pieces of sending destination information correspond to each other (S21). Next, the second extraction result output unit 23 performs statistical processing on values included in a field of interest for each group. Specifically, suppose in this case that the number of credit cards used is calculated by counting the number of card number hash values (S22). Further, the second extraction result output unit 23 generates summary data SD by extracting the sending destination information satisfying the second extraction condition that the number of credit cards which number is calculated in S22 is a predetermined number or more (S23).

The second extraction result output unit 23 thereafter generates detail data DD by enumerating aggregation object records corresponding to each summary record included in the summary data SD generated in S23 (S24). Further, the second extraction result output unit 23 determines whether or not each of the aggregation object records added to the detail data DD is recorded in the canceled order log, and adds flag information indicating a result of the determination to each of the aggregation object records (S25).

Next, the second extraction result output unit 23 generates detail data DDi for a card company by excluding the contents of records of orders not using credit cards of the card company as the provision destination from the detail data DD to which the flag information is added in S25 (S26). Then, the second extraction result output unit 23 determines whether card company-destined detail data DDi is generated for all of card companies as provision objects (S27). The processing is ended after the card company-destined detail data DDi is generated for all of the card companies as provision destinations.

According to the monitoring assistance device 1 according to the present embodiment described above, it is possible to detect suspicious orders such as cannot be detected by a single piece of processing by combining the first extraction processing based on comparison with the extraction object list BL and the second extraction processing based on aggregation using a predetermined field as a key. Specifically, the monitoring person monitors suspicious order information extracted according to the first extraction condition, and when there is a really suspicious order, the monitoring person picks up the suspicious order. Thus, as compared with whole quantity visual inspection, it is possible to achieve both of a reduction in a load on the monitoring person and maintenance and improvement of accuracy of fraud detection. Further, by examining the second extraction result R2 statistically extracted according to the second extraction condition, it is possible to immediately detect methods of new frauds such as cannot be detected from the first extraction condition, and reflect the methods of the new frauds in the first extraction condition. In particular, the application of such processing to the electronic mall service can reduce the risk of chargebacks for credit card member stores.

In addition, as one of features of the monitoring assistance device 1 according to the present embodiment, suspicious orders are detected with attention directed to sending destination information. The inventor of the present application has found the following points from experience and trial and error as a person skilled in the art. When a fraudulent orderer intends to obtain a product by fraud using a fraudulent credit card such as a credit card of another person or the like, the sending destination of the product needs to be a place where the orderer can receive the product. Hence, the sending destinations of fraudulent orders naturally become the same or similar. Accordingly, accuracy of detection of frauds can be improved by extracting order information matching suspicious sending destination information listed in the extraction object list BL in advance and presenting the order information to the monitoring person. That is, order information extracted in such a manner is highly likely to represent a fraudulent order. In addition, in transactions involving the delivery of products in e-commerce, sending destination addresses are always input when orders are placed. Thus, almost all of order information can be checked, and there are fewer oversights. Further, according to the above-described tendency in regard to the sending destinations of fraudulent orders, the fraudulent orders can be identified more effectively by using a result of aggregation using the sending destination information as a key.

It is to be noted that embodiment of the present invention is not limited to the embodiment described above. For example, it is assumed in the above description that the monitoring person performs monitoring work on the monitoring assistance device 1. However, the monitoring assistance device 1 may transmit the first extraction result R1 and the second extraction result R2 to another terminal device, and the monitoring person may monitor the first extraction result R1 and the second extraction result R2 on the terminal device. In addition, the functions of the monitoring assistance device 1 and the electronic commerce server 2 may be implemented on a same computer.

In addition, the above description has been made of electronic commerce by an electronic mall service. However, without being not limited to this, the monitoring assistance device 1 may perform the first extraction processing and the second extraction processing for orders in electronic commerce which orders are received by a single store.

### REFERENCE SIGNS LIST

1 Monitoring assistance device, 11 Control unit, 12 Storage unit, 13 Communicating unit, 14 Operating unit, 15 Display unit, 21 Received order data obtaining unit, 22 First extraction result output unit, 23 Second extraction result output unit.

1-15. (canceled)

16. A computer architecture for use in monitoring orders received by electronic commerce, the computer architecture comprising:
at least one memory configured to store computer program code;
at least one processor configured to access said at least one memory and operate as instructed by said computer program code, said computer program code including:
obtaining code configured to cause at least one of said at least one processor to obtain a plurality of order records each including a plurality of fields indicating contents of an order;
extracting code configured to cause at least one of said at least one processor to exract a plurality of aggregation object records by performing aggregation processing on a plurality of order records within a predetermined period in a past with a predetermined field including information identifying an orderer as a key;
determining code configured to cause at least one of said at least one processor to determine whether or not orders included in the plurality of aggregation object records have a high probability of being fraudulent on a basis of whether or not a value of a field of interest included in the plurality of aggregation object records satisfies a predetermined condition;
adding code configured to cause at least one of said at least one processor to add a value of a predetermined field included in the aggregation object records to an extraction object list for determining whether or not orders have a high probability of being fraudulent when determining that the orders included in the plurality of aggregation object records have a high probability of being fraudulent;
comparing code configured to cause at least one of said at least one processor to determine whether or not an order related to a newly obtained order record has a high probability of being fraudulent by comparing a value of the predetermined field in the newly obtained order record with the value of the predetermined field included in the extraction object list; and
outputting code configured to cause at least one of said at least one processor to output the newly obtained order record when it is determined that the order related to the order record has a high probability of being fraudulent.

17. The computer architecture according to claim 16, wherein
the predetermined field includes product sending destination information.

18. The computer architecture according to claim 16, wherein
when determining that the orders included in the plurality of aggregation object records have a high probability of being fraudulent, the determining code causes at least one of said at least one processor to output information indicating contents of each of the plurality of aggregation object records as at least a part of a determination result.

19. The computer architecture according to claim 18, wherein
for the order records extracted by the extracting code, the comparing code is further configured to cause at least one of said at least one processor to determine whether or not the orders have a high probability of being fraudulent by comparing the value of the predetermined field in the order records with the value of the predetermined field included in the extraction object list,
the computer architecture further comprises recording code configured to cause at least one of said at least one processor to record, as a canceled record, an order record of an order determined to have a high probability of being fraudulent by the comparing code and canceled, and
the determining code causes at least one of said at least one processor to output the determination result in a mode in which the order record recorded as the canceled record among the plurality of aggregation object records determined to have a high probability of being fraudulent is distinguishable from order records of orders that are not canceled.

20. The computer architecture according to claim 18, wherein
the determining code is configured to cause at least one of said at least one processor to add, to each of the plurality of aggregation object records determined to have a high probability of being fraudulent, information about a result of comparing the value of the predetermined field in the aggregation object record with the value of the predetermined field included in the extraction object list, and output the determination result.

21. The computer architecture according to claim 20, wherein
the determining code is configured to cause at least one of said at least one processor to compare sending destination information included in each of the plurality of aggregation object records determined to have a high probability of being fraudulent with sending destination information included in the extraction object list, add information indicating a degree of similarity between the two pieces of sending destination information to the aggregation object record, and output the information as the determination result.

22. The computer architecture according to claim 18, wherein
the determining code is configured to cause at least one of said at least one processor to output the determination result in a mode in which an order record of an order received by a predetermined monitoring object store among the plurality of aggregation object records determined to have a high probability of being fraudulent is distinguishable from the order records of the other orders.

23. The computer architecture according to claim 18, wherein
the determining code is configured to cause at least one of said at least one processor to generate data to be provided to a card company as a provision destination by excluding, from the determination result, contents of order records of orders not using credit cards of the card company among the plurality of aggregation object records included in the determination result.

24. The computer architecture according to claim 16, wherein
the comparing code is configured to cause at least one of said at least one processor to periodically perform determination processing of determining whether or not each of a plurality of order records obtained within a predetermined period in the past has a high probability of being fraudulent,
the extracting code is configured to cause at least one of said at least one processor to periodically perform extraction processing of extracting a plurality of aggregation object records from a plurality of order records obtained within a predetermined period in the past, and
each time the extracting code causes at least one of said at least one processor to extract a plurality of aggregation object records, the determining code causes at least one of said at least one processor to determine whether or not orders included in the plurality of aggregation object records have a high probability of being fraudulent.

25. The computer architecture according to claim 24, wherein
each time a first period of a predetermined length elapses, the comparing code causes at least one of said at least one processor to perform the determination processing for a plurality of order records obtained within the first period, and
the extracting code causes at least one of said at least one processor to perform the extraction processing for a plurality of order records obtained within a second period longer than the first period.

26. The computer architecture according to claim 17, wherein
the comparing code is configured to cause at least one of said at least one processor to determine whether or not the product sending destination information included in the newly obtained order record is similar to sending destination information included in the extraction object list by comparing a numerical string formed by a number extracted from the product sending destination information with a numerical string formed by a number extracted from the sending destination information included in the extraction object list.

27. The computer architecture according to claim 17, wherein
the comparing code is configured to cause at least one of said at least one processor to compare the sending destination information included in the order record extracted as a result of the comparison with sending destination information determined to be safe, the sending destination information determined to be safe being included in an exclusion object list prepared in advance, and determine that a probability of the order being fraudulent is not high when the two pieces of sending destination information are determined to coincide with each other or be similar to each other as a result of the comparison.

28. A method of controlling a computer architecture for use in monitoring orders received by electronic commerce, the method making the computer architecture:
obtain an order record including a plurality of fields indicating contents of an order;
extract a plurality of aggregation object records by performing aggregation processing on a plurality of order records within a predetermined period in a past with a predetermined field including information identifying an orderer as a key;
determine whether or not orders included in the plurality of aggregation object records have a high probability of being fraudulent on a basis of whether or not a value of a field of interest included in the plurality of aggregation object records satisfies a predetermined condition;
add a value of a predetermined field included in the aggregation object records to an extraction object list for determining whether or not orders have a high probability of being fraudulent when determining that the orders included in the plurality of aggregation object records have a high probability of being fraudulent;
determine whether or not an order related to a newly obtained order record has a high probability of being fraudulent by comparing a value of the predetermined field in the newly obtained order record with the value of the predetermined field included in the extraction object list; and
output the newly obtained order record when it is determined that the order related to the order record has a high probability of being fraudulent.

29. A non-transitory computer readable meeting having stored thereon a computer program for instructing a computer to monitor orders received by electronic commerce, said computer program causing the computer to:
obtain an order record including a plurality of fields indicating contents of an order;
extract a plurality of aggregation object records by performing aggregation processing on a plurality of order records within a predetermined period in a past with a predetermined field including information identifying an orderer as a key;
determine whether or not orders included in the plurality of aggregation object records have a high probability of being fraudulent on a basis of whether or not a value of a field of interest included in the plurality of aggregation object records satisfies a predetermined condition;
add a value of a predetermined field included in the aggregation object records to an extraction object list for determining whether or not orders have a high probability of being fraudulent when determining that the orders included in the plurality of aggregation object records have a high probability of being fraudulent;
determine whether or not an order related to a newly obtained order record has a high probability of being fraudulent by comparing a value of the predetermined field in the newly obtained order record with the value of the predetermined field included in the extraction object list; and
output the newly obtained order record when it is determined that the order related to the order record has a high probability of being fraudulent.
